(19) United States
(12) Patent Application Publication
(10) Pub. No.: US 2010/0019685 A1
(43) Pub. Date: Jan. 28, 2010

(54) DIELECTRIC BARRIER DISCHARGE LAMP LIGHTING APPARATUS

(75) Inventors: Satoshi Kominami, Osaka (JP); Kiyoshi Hashimotodani, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/159,894

(22) PCT Filed: Sep. 7, 2007
(86) PCT No.: PCT/JP2007/067476

§ 371 Date: Jul. 2, 2008

(30) Foreign Application Priority Data
Mar. 26, 2007 (JP) 2007-078493

(51) Int. Cl. H05B 41/24

(52) U.S. Cl. 315/250

(57) ABSTRACT

A dielectric barrier discharge lamp lighting apparatus includes a plurality of dielectric barrier discharge lamps each of which includes an internal electrode sealed at one end, an external electrode arranged outside of a discharge space of the dielectric barrier discharge lamps, and a ballast circuit for applying a high voltage at high frequency between the internal electrode and the external electrode to operate the plurality of dielectric barrier discharge lamps. The plurality of lamps are arranged in parallel, and arranged so that the position of the internal electrode of each dielectric barrier discharge lamp is at different side in the adjacent dielectric barrier discharge lamps, and at the same sides in every other dielectric barrier discharge lamp. The ballast circuit applies voltages at high frequency with difference in phase to adjacent dielectric barrier discharge lamps.

### TECHNICAL FIELD

The present invention relates to a discharge lamp lighting apparatus with external electrode for operating a lamp with dielectric barrier discharge, and more specifically to an apparatus for operating a dielectric barrier discharge lamp by applying a substantially rectangular wave voltage, the dielectric barrier discharge lamp capable of being operated with a pulse current flowing when a voltage of the substantially rectangular wave voltage is changed.

### BACKGROUND ART

Recently, a rare gas discharge lamp with external electrode which is operated with dielectric barrier discharge has been intensively studied for backlight for a liquid crystal display or the like. This is because mercury is not used in the rare gas discharge lamp and thus the light emission efficiency is not lowered by elevation of mercury vapor pressure, and it is also preferable from the environmental point of view.

In lighting operation by using dielectric barrier discharge, the dielectric layer is charged by applying a driving voltage, and discharge is induced by a high voltage generated when the driving voltage is inverted. To do so, a rectangular wave voltage at high frequency is used as the driving voltage. The dielectric barrier discharge has characteristics in that a load characteristic of the lamp is a capacitive positive characteristic and thus plural lamps can be operated in parallel by a single ballast circuit.

Patent document 1 discloses an example of a discharge lamp lighting apparatus using dielectric barrier discharge. FIG. 7 shows a configuration of discharge lamp lighting apparatus disclosed in patent document 1. FIG. 7A is a plan view of the discharge lamp lighting apparatus, FIG. 7B is a plan view showing a rear side of the discharge lamp lighting apparatus, and FIG. 7C is a sectional view of the discharge lamp lighting apparatus shown in FIG. 7A.

In FIGS. 7A to 7C, the discharge lamp lighting apparatus includes a reflector 101, an external electrode 102 arranged on the reflector 101, and a discharge lamp 103 contacting with the external electrode 102 and arranged on the reflector 101. The discharge lamp 103 has an internal electrode 104 internally provided at one end. The discharge lamp lighting apparatus also includes a ballast circuit 105 for operating the discharge lamp 103 by applying a high voltage at high frequency between the external electrode 102 and the internal electrode 104. The ballast circuit 105 and the internal electrode 104 are connected electrically via a high voltage wire 106.

The reflector 101 has a function of reflecting the light emitted from the discharge lamp 103. The reflector 101 has a groove for fitting the discharge lamp 103, in which the discharge lamp is fixed with an adhesive agent, an adhesive tape or the like. The external electrode 102 is formed on the reflector 101 by printing or the like, and is disposed orthogonally to the tube axial direction of the discharge lamp 103. The external electrode 102 is fixed at a GND potential connected to a low voltage output of the ballast circuit 105 by way of a lead wire.

The discharge lamp 103 has a discharge tube made of a transparent material (for example, borosilicate glass), and is filled with a discharge gas mainly composed of Xe in a pressure range of 2 kPa to 35 kPa. The inner wall of the discharge tube is coated with a phosphor appropriately blended for RGB so as to obtain a desired light. The internal electrode 104 formed of a metal such as nickel or niobium, and is connected to a high voltage output of the ballast circuit 105 by way of a lead wire. The ballast circuit 105 is composed of an inverter circuit of push-pull type using a step-up transformer or half-bridge type using a step-up transformer, for converting the entered direct-current voltage into a rectangular wave high voltage at high frequency (for example, 20 kHz, 3 kVp-p).

The operation of the conventional discharge lamp lighting apparatus having the above-described configuration is described below. When the power source (not shown) is turned on, the ballast circuit 105 generates a rectangular wave high voltage at high frequency. The high voltage at high frequency applied between the external electrode 102 and the internal electrode 104 causes discharge in the discharge tube. Upon start of the discharge, the discharge gas, Xe, generates an ultraviolet ray of 172 nm by excimer emission. The generated ultraviolet ray is converted into a visible light by the phosphor applied on the inner wall of the discharge tube. The visible light from the discharge lamp 103 is reflected by the reflector 101, and is formed as a uniform plane light source through a diffusion plate or lens sheet (not shown), and is used as a backlight for a liquid crystal display.

Patent document 1: JP-A-2003-168304(see FIGS. 1 and 2).

### DISCLOSURE OF INVENTION

More recently, a liquid crystal display (LCD) television of 30-inch size has been increased in size to 40 inch or larger. Along with the increase in size of the LCD television, the light source used for backlight of the liquid crystal display needs to be larger in size.

It is generally known that the lamp voltage (breakdown voltage) depends on the lamp length in the field of discharge lamp lighting apparatus using internal and external electrodes type dielectric barrier discharge. This is because a stronger electric field is needed for generating a plasma at a position remote from the internal electrode.

That is, a higher lamp voltage is needed to be applicable to a large-sized LCD TV.

When the lamp voltage becomes higher, the insulation measure is particularly complicated in the ballast circuit, and the ballast circuit is increased in size, and the manufacturing cost is increased.

The invention is devised in the light of these problems, and it is hence an object thereof to present a lighting apparatus of a dielectric barrier discharge lamp capable of lowering the lamp voltage.

### MEANS FOR SOLVING THE PROBLEMS

A dielectric barrier discharge lamp lighting apparatus according to the invention includes a plurality of dielectric barrier discharge lamps each of which includes a discharge tube and an internal electrode sealed at one end of the discharge tube, an external electrode arranged outside of a discharge space of the dielectric barrier discharge lamps, and a ballast circuit for applying a high voltage at high frequency between the internal electrode and the external electrode to operate the plurality of dielectric barrier discharge lamps. The plurality of dielectric barrier discharge lamps are arranged in parallel, and arranged so that the position of the internal electrode of each dielectric barrier discharge lamp is at different side in the adjacent dielectric barrier discharge lamps, and at the same sides in every other dielectric barrier discharge lamp. The ballast circuit applies voltages at high frequency with difference in phase to adjacent dielectric barrier discharge lamps.

According to the lighting apparatus, there is a phase difference in voltages at high frequency applied to the adjacent dielectric barrier discharge lamps, and thus the lamp voltage when operating can be lowered.

The difference in phase may be 180 degrees. By this configuration, the lamp voltage is more significantly lowered.

The interval of dielectric barrier discharge lamps may be 50 mm or less. By this configuration, the lamp voltage is more significantly lowered.

According to the invention, in the dielectric barrier discharge lamp lighting apparatus for operating by applying a voltage at high frequency to a plurality of dielectric barrier discharge lamps having internal electrodes, the lamp voltage can be lowered because there is a difference in phase of voltages at high frequency applied to the adjacent dielectric barrier discharge lamps. It can be hence used in light sources of various applications, and outstanding effects are obtained.

### BRIEF DESCRIPTION OF DRAWINGS

FIGS. 1A and 1B are diagrams of a configuration of a dielectric barrier discharge lamp lighting apparatus according to an embodiment of the invention.

FIG. 2 is a block diagram of a dielectric barrier discharge lamp according to the embodiment of the invention.

FIG. 3 is a circuit diagram of a dielectric barrier discharge lamp lighting apparatus according to the embodiment of the invention.

FIGS. 4A and 4B are diagrams showing an output voltage waveform of the dielectric barrier discharge lamp lighting apparatus according to an embodiment of the invention (a ballast circuit 4a and a ballast circuit 4b, respectively).

FIG. 5 is a diagram showing measured values of lamp voltage with respect to a phase difference in applied voltages to plural dielectric barrier discharge lamps arranged in parallel.

FIG. 6 is a diagram showing other example of an external electrode shape.

FIGS. 7A to 7C are block diagrams of a conventional dielectric barrier discharge lamp lighting apparatus.

### REFERENCE SIGNS

1 Dielectric barrier discharge lamp
2 Internal electrode
3 External electrode
4a, 4b ballast circuit
5 Discharge tube
6 Phosphor
7 Direct-current power source
8 Driving circuit
9, 10 FET
11 Step-up transformer

### BEST MODE FOR CARRYING OUT THE INVENTION

A preferred embodiment of the invention is explained below with reference to the accompanying drawings.

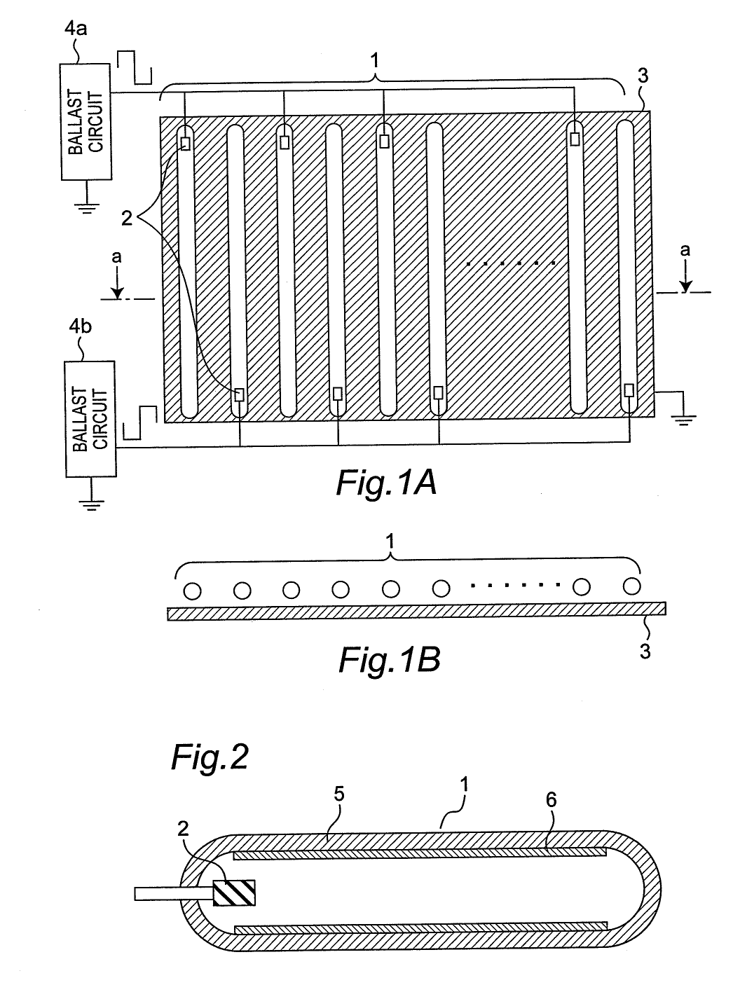

FIG. 1A is a plan view of a dielectric barrier discharge lamp lighting apparatus according to an embodiment of the invention, and FIG. 1B is a sectional view of the dielectric barrier discharge lamp lighting apparatus along line a-a in FIG. 1A.

The dielectric barrier discharge lamp lighting apparatus in the embodiment includes a plurality of (for example, thirty-two) dielectric barrier discharge lamps 1 having an internal electrode 2 sealed at one end, an external electrode 3 arranged commonly on each dielectric barrier discharge lamp 1, and two ballast circuits 4a and 4b for applying a voltage at high frequency between the internal electrode 2 and the external electrode 3 to operate the dielectric barrier discharge lamps 1.

The dielectric barrier discharge lamp 1 has a structure as shown in FIG. 2, for example. The dielectric barrier discharge lamp 1 includes a cylindrical discharge tube 5. The discharge tube 5 is made of borosilicate glass or the like which is excellent in transparency of visible light (380 nm to 770 nm), and has a cylindrical shape of 3 mm in outside diameter, 2 mm in inside diameter, and 370 mm in length. The discharge tube 5 is filled with mixed gas mainly composed of xenon as discharge gas, and the pressure is, for example, 20 kPa. Other mixed gas components than xenon include helium, neon, argon, krypton, and other rare gases. The mixing ratio of xenon and other gas is, for example, 6:4.

The inner surface of the discharge tube 5 is coated with phosphor 6. At one end of the discharge tube 5, an internal electrode made of metal such as nickel or niobium is sealed, and is electrically led to outside of the discharge tube 5 by a lead wire.

The dielectric barrier discharge lamp 1 is spaced from the external electrode 3 as shown in FIG. 1B. A spacer (not shown) keeps a distance between the dielectric barrier discharge lamp 1 and the external electrode 3 at 5 mm, for example, and the interval of the dielectric barrier discharge lamps 1 at 22 mm, for example. The spacer is made of white or transparent resin or the like in order to avoid the absorption of the light as much as possible.

The external electrode 3 is made of a conductive metallic material such as aluminum plate, which has a function of reflecting the light from the dielectric barrier discharge lamp to the front side. The reflecting function is easily realized by evaporating silver on the surface of a flat aluminum plate or the like.

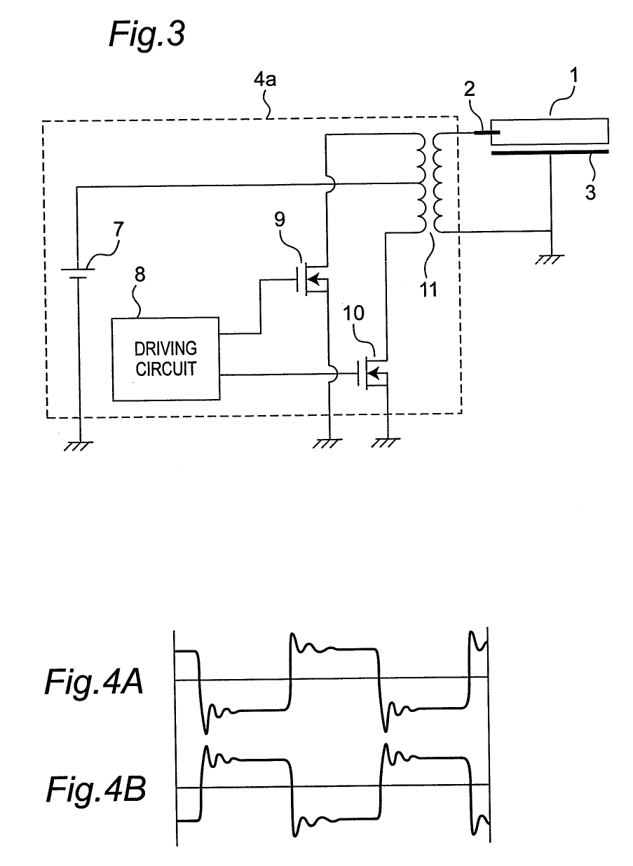

FIG. 3 shows an example of the ballast circuit 4a. FIG. 1 shows thirty-two dielectric barrier discharge lamps 1, but FIG. 3 shows only one dielectric barrier discharge lamp for simplification of the explanation.

The ballast circuit 4a is an inverter circuit of push-pull type. The ballast circuit 4a includes a direct-current power source 7, a driving circuit 8, FETs 9 and 10 as switching element, and a step-up transformer 11. The direct-current power source 7 and the FETs 9 and 10 are connected to a primary winding of the step-up transformer 11. The driving circuit 8 outputs gate signals to the FETs 9 and 10 to turn on and off the FETs 9 and 10 alternately. The driving circuit 8 may be easily composed of a commercial IC or the like. The step-up transformer 11 transforms the direct-current voltage from the direct-current power source 7 into a rectangular wave high voltage at high frequency. One end of a secondary winding of the step-up transformer 11 is connected to the internal electrode 2 of the dielectric barrier discharge lamp 1, and the other end is connected to the external electrode 1 and the GND. The frequency in this case depends on the frequency of the output signal of the driving circuit 8, which is, for example, 20 kHz. The step-up ratio depends on the ratio in number of turns of the primary winding and secondary winding of the step-up transformer 11. For example, direct-current 24 Volt is converted into a rectangular wave voltage of 6 kVp-p. At this time, the output voltage of the step-up transformer 11 is not always an ideal rectangular waveform, but includes some of ringing component due to influence of leakage inductance or parasitic capacity of the step-up transformer 11. The value of 6 kVp-p described above is a peak-to-peak value including the ringing components.

The ballast circuit 4b has basically the same configuration as the ballast circuit 4a. It is different that the phase of the output voltage waveform of the ballast circuit 4b is in antiphase to the phase of the ballast circuit 4a. A voltage waveform in antiphase can be produced easily by, for example, making the gate signal to the FETs of the ballast circuit 4b opposite to that of the ballast circuit 4a.

FIGS. 4A and 4B show examples of output voltage waveform from the ballast circuits 4a and 4b, respectively.

According to this configuration, a rectangular wave high voltage at high frequency from the ballast circuits 4a and 4b is applied between the internal electrode 2 and the external electrode 3 of the dielectric barrier discharge lamp 1. As a result, when the voltage value of the rectangular wave high voltage at high frequency changes, that is, when the polarity of the voltage is inverted, a pulse current flows between the internal electrode 2 and the external electrode 3, so that dielectric barrier discharge occurs in the dielectric barrier discharge lamp 1. At this time, the discharge tube 5, and a gap between dielectric barrier discharge lamp 1 and external electrode 3 acts as a dielectric element. When the dielectric barrier discharge is started, xenon filled in the discharge tube 5 is excited by electrons, radiating an ultraviolet ray. The ultraviolet ray is converted into a visible light by the phosphor 6 coated on the inner wall of the discharge tube 5, and thus the dielectric barrier discharge lamp 1 emits light. Generally, in lighting operation by dielectric barrier discharge using xenon, the excimer emission of xenon is increased, resulting in more ultraviolet rays emitted and higher luminous efficiency, by operating with a rectangular voltage rather than a sinusoidal voltage.

In the preferred embodiment, while the dielectric barrier discharge lamp 1 is operating, a voltage waveform of antiphase is applied to an adjacent dielectric barrier discharge lamp 1. Therefore a specified electric power can be provided even at a relatively low lamp voltage.

Herein, the reason why the lamp voltage can be lowered by applying a voltage waveform of antiphase is explained specifically by showing results of an experiment.

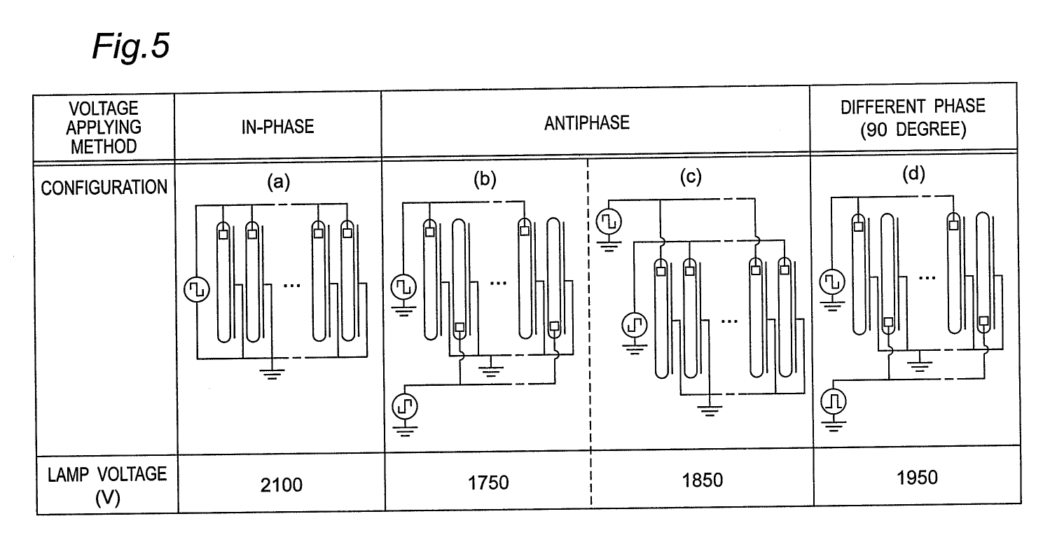

The experiment measured a lamp voltage when thirty-two dielectric barrier discharge lamps were operated with applied electric power at 100 W. The dielectric barrier discharge lamp used in the experiment included a discharge tube which had an outside diameter of 3 mm, an inside diameter of 2 mm, and length of 370 mm, one end of which is provided with a cup electrode made of Ni, and which is filled with Xe gas at 140 Torr. These thirty-two dielectric barrier discharge lamps were arranged above the external electrode of flat aluminum plate at intervals of 22 mm, and distance of 5 mm between external electrode and dielectric barrier discharge lamp. The voltage applied between the internal electrode and the external electrode was a rectangular voltage of 20 kHz. FIG. 5 shows the results of measurement.

In FIG. 5, the results of measurement are shown for the following four types of configuration.

TABLE 1

| | Phase difference | Position of |
|---|---|---|
| | in output voltages of | internal |
| Configuration | ballast circuits 4a and 4b | electrode |
| (a) | 0 deg. (in-phase) | same side |
| (b) | 180 deg. (antiphase) | alternate |
| (c) | 180 deg. (antiphase) | same side |
| (d) | 90 deg. | alternate |

As known from FIG. 5, although the total power applied to the dielectric barrier discharge lamps is 100 W constant, when the difference in phase of voltage at high frequency applied to adjacent dielectric barrier discharge lamps is 90 degrees (configuration (d)), as compared with configuration (a) of in-phase, the lamp voltage is lowered by about 10%. When the voltages at high frequency applied to adjacent dielectric barrier discharge lamps are in antiphase (configurations (b) and (c)), as compared with configuration (a) of in-phase, the lamp voltage is lowered further. In particular, in configuration (b) of alternate arrangement of internal electrodes, the lamp voltage is lowered by about 20%.

This cause of lowering of lamp voltage is estimated as follows.

The dielectric barrier discharge lamps are considered to be substantially capacitors in terms of an equivalent circuit. That is, when a voltage is applied, a positive or negative charge is charged to the dielectric barrier discharge lamps depending on the polarity of the voltage. An electric field is generated and attractive force or repulsive force between charges depending on the polarity of charges may occur. Thus each dielectric barrier discharge lamp receives the influence of the electric field from the adjacent dielectric barrier discharge lamps.

As shown in configuration (a), when the voltages in phase are applied to all dielectric barrier discharge lamps, all dielectric barrier discharge lamps are charged with electric charges of the same polarity, and the charge in each dielectric barrier discharge lamp receives the repulsive force due to the influence of the electric field from the adjacent dielectric barrier discharge lamps. This repulsive force is considered to act to block the motion of the charge in the dielectric barrier discharge lamps. Accordingly, unless the lamp voltage applied between the internal electrode and the external electrode is raised, specified electric power necessary for operating the dielectric barrier discharge lamps cannot be entered.

On the other hand, when voltages in antiphase are applied to adjacent dielectric barrier discharge lamps as configuration (b) or (c), each dielectric barrier discharge lamp is charged with opposite polarity of electric charge in adjacent dielectric barrier discharge lamps. Accordingly, the charge in each dielectric barrier discharge lamp is subjected to the attractive force due to the influence of the electric field from the adjacent dielectric barrier discharge lamps. This attractive force is considered to act to promote the motion of the charge in the dielectric barrier discharge lamps, oppositely to the case above.

In particular, as shown in configuration (b), when the internal electrodes are arranged alternately on different side, voltages in antiphase are applied to the adjacent dielectric barrier discharge lamps, and thus an electric field nearly along the lamp axis is generated from the internal electrode of the lamp. Due to the influence of the electric field occurring in the adjacent dielectric barrier discharge lamps, a force for moving the charge away from the internal electrode is generated in each dielectric barrier discharge lamp. Thus it is considered that more charges are moved relatively easily at a lower voltage. Owing to these factors, when a voltage of antiphase is applied, it is estimated that the lamp voltage was lowered by about 20% at maximum.

As shown in configuration (c) where the internal electrodes are arranged on the same side, as compared with the internal electrodes arranged alternately on different side as shown in configuration (b), the level of lowering the lamp voltage was slightly smaller. When the internal electrodes are arranged alternately on different side, the electric field is generated nearly along the lamp axis as stated above, while the internal electrodes are arranged on the same side, it is considered that the electric field is generated nearly orthogonally to the lamp axis. Due to difference in direction of the generated electric field, it is estimated that a difference occurs in level of lowering the lamp voltage.

As shown in configuration (b), when the internal electrodes are arranged alternately on different side, an electric field nearly along the lamp axis is generated, and each dielectric barrier discharge lamp emits light relatively uniformly in the lamp axial direction, which is considered to be a secondary effect. From these facts, it seems desirable to arrange the internal electrodes alternately on different side, rather than to arrange the internal electrodes at the same side.

The phase difference of output voltages of ballast circuits 4a and 4b to obtain the decreasing effect of lamp voltage is not limited to 90 degrees or 180 degrees. If only a slight phase difference is present, the decreasing effect of the lamp voltage is obtained. This is specifically explained below.

Considering the rate of time periods of attractive force and repulsive force generated between the adjacent dielectric barrier discharge lamps 1, the decreasing level of lamp voltage when applying a voltage with a phase difference can be estimated. That is, in the case of in-phase (phase difference=zero degree), the repulsive force acts in all time during one period, and thus the lamp voltage reaches the highest. In the case of antiphase (phase difference=180 degrees), the attractive force acts in all time during one period, and thus the lamp voltage reaches the lowest. In other cases than the case where the phase difference is zero degree (in phase) or 180 degrees (antiphase), the lamp voltage becomes a voltage between the lamp voltage in phase and lamp voltage in antiphase, depending on the acting time of attractive force and repulsive force. For example, when the phase difference is 90 degrees, the attractive force acts in a half of one period and the repulsive force acts in the other half, and thus the lamp voltage seems to be a nearly intermediate lamp voltage between the lamp voltage in phase and lamp voltage in reverse phase.

Hence even if a slight phase difference exists, a time for which the attractive force works exists. Therefore the lamp voltage is lower as compared with in-phase case. However, to obtain a sufficient decreasing effect of lamp voltage, it is desired to have a time for which the attractive force works is more than half of one period, and hence the phase difference is desired to be between 90 degrees and 270 degrees.

When the lamp voltage is lower, the output voltages from the ballast circuits 4a and 4b are lower, and therefore in particular the step-up transformer 11 can be reduced in size and saved in cost. Since the step-up transformer 11 is a relatively large and expensive component among parts for composing the ballast circuit 4a, and therefore reduction of size and cost of the ballast circuit 4a may be expected.

In the preferred embodiment, the dielectric barrier discharge lamp 1 is 3 mm in outside diameter, 2 mm in inside diameter, and 370 mm in length. However the dimensions are not limited to these and the other dimensions may be applied. The material of the internal electrode 2 is nickel, but niobium or other electrode material may be used. Although the internal electrode 2 is of cup shape, it may be of bar-shape or other shapes. The discharge tube 16 is borosilicate glass, but soda glass, quartz glass, or other material may be used for the discharge tube 16.

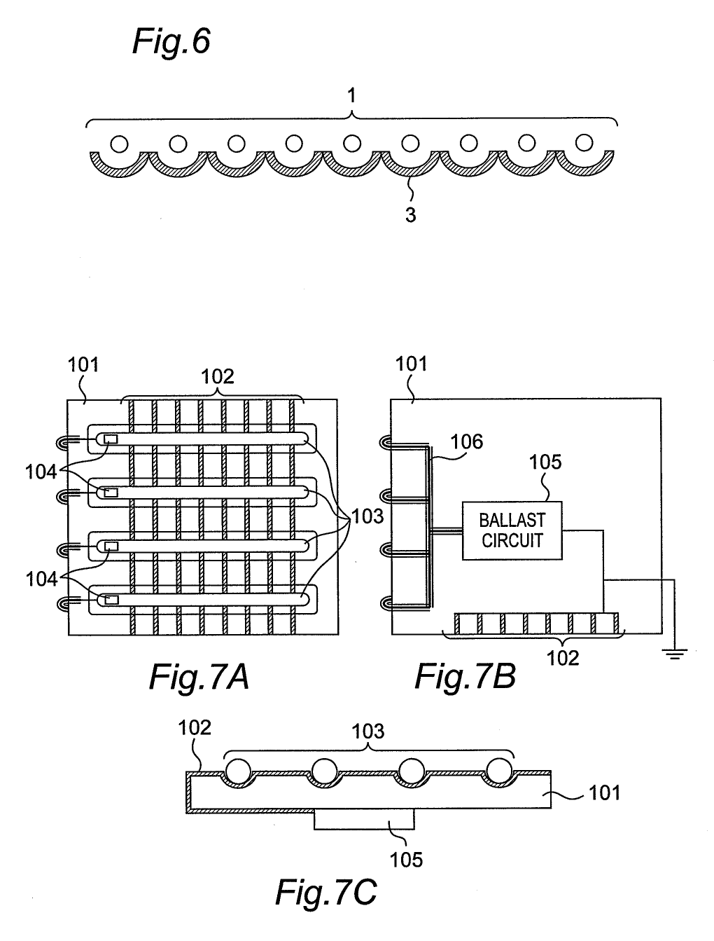

The external electrode 3 is made of aluminum in the present embodiment, but copper, iron, or other metals may be used. The function of reflection of the external electrode 3 is not an essential function, and the reflection may be realized by reflection sheet or the like. The external electrode 3 is a flat plate, but may be formed in other shape, such as corrugated structure as shown in FIG. 6. The external electrode is shown as one external electrode common to each dielectric barrier discharge lamps 1, but may be formed of a plurality of external electrodes if connected electrically. However, as shown in FIG. 1 or FIG. 6, when one large external electrode 3 is used commonly for a plurality of dielectric barrier discharge lamps 1, it is easier and advantageous when assembling a liquid crystal display backlight. It is also advantageous from the viewpoint of suppression of noise when one large external electrode 3 is used commonly for a plurality of dielectric barrier discharge lamps 1. This is because the decreasing effect of radiation noise is obtained when an external electrode 3 of large GND potential is arranged near the noise source of the dielectric barrier discharge lamps 1 where a high voltage is applied.

The distance between the dielectric barrier discharge lamp 1 and the external electrode 3 is 5 mm. However The distance may preferably be 20 mm or less from the viewpoint of luminous efficiency of the dielectric barrier discharge lamps 1. When the distance between the dielectric barrier discharge lamp 1 and the external electrode 3 is longer, a larger voltage is applied to the space formed by the dielectric barrier discharge lamp 1 and the external electrode 3, and hence the lamp voltage increases. The invention seems to be particularly effective to a lighting apparatus for a dielectric barrier discharge lamp 1 with a gap provided between the lamp and the external electrode 3.

Although the distance between adjacent dielectric barrier discharge lamps 1 is 22 mm, the distance is not limited to this. At this time, the level of the effect due to the adjacent dielectric barrier discharge lamps 1 varies depending on the distance between dielectric barrier discharge lamps 1, and thus the lamp voltage is lower when the distance between dielectric barrier discharge lamps 1 is shorter. On the other hand, it is estimated that, when a voltage in phase is applied to all dielectric barrier discharge lamps 1 as in the prior art, the lamp voltage increases, as the distance between dielectric barrier discharge lamps 1 becomes shorter. That is, as the distance between dielectric barrier discharge lamps 1 becomes shorter, the effect of lowering the lamp voltage is relatively larger. Therefore to make full use of the decreasing effect of lamp voltage, the distance between dielectric barrier discharge lamps 1 is preferably 50 mm or less.

The distance between dielectric barrier discharge lamps 1 affects the thickness of the backlight for liquid crystal display. The liquid crystal display is noted for its thin size, but the thin structure is a perpetual desire, and thinning the backlight for liquid crystal display is indispensable matter. The method of thinning the backlight may be realized by increasing the number of dielectric barrier discharge lamps 1 and shortening the distance between the lamps and the optical members (diffusion plate, lens sheets, others, not shown). By increasing the number of dielectric barrier discharge lamps 1, the distance between dielectric barrier discharge lamps 1 is shorter, and hence the lamp voltage can be lowered as discussed above. That is, the invention seems to be more effective, when the number of dielectric barrier discharge lamps 1 is increased for thinning the backlight for liquid crystal display.

The pressure of the discharge gas filled is 20 kPa but it is not limited to this. It may be a value in a range of 5 to 35 kPa.

The number of dielectric barrier discharge lamps 1 is thirty-two, but it is not limited to this value.

The ballast circuits 4a and 4b are push-pull type. But it may be realized by half-bridge type, full-bridge type, or other type. The direct-current power source 7 is easily realized by a battery, chopper circuit, or the like. Instead of the FETs 9 and 10, bipolar transistors, IGBTs, and others may be used. The driving frequency is 20 kHz, but it is preferably in a range of 5 to 30 kHz from the viewpoint of luminous efficiency. The output voltage of the step-up transformer 5 is 6 kVp-p, but the value varies with the length of dielectric barrier discharge lamps 1, filling gas pressure and other design factors. The value may vary depending on the dielectric barrier discharge lamps 1.

### INDUSTRIAL APPLICABILITY

As described above, according to the present invention, in the apparatus for operating a plurality of dielectric barrier discharge lamps with internal-external electrode system, a voltage is applied to each dielectric barrier discharge lamp so that the voltage applied to adjacent lamps are in antiphase, and thus the lamp voltage can be lowered and the ballast circuits can be reduced in size and saved in cost. Accordingly, the dielectric barrier discharge lamp lighting apparatus of the invention is very useful as the light source for backlight of liquid crystal display, light source of copier and scanner, or ultraviolet light source for sterilization and UV cleaning, and others.

1. A dielectric barrier discharge lamp lighting apparatus comprising:
a plurality of dielectric barrier discharge lamps each including a discharge tube and an internal electrode, the plurality of dielectric barrier discharge lamps being oriented such that the internal electrodes are alternately located at opposite ends of adjacent discharge tubes;
an external electrode arranged outside a discharge space of each of the dielectric barrier discharge lamps; and
a ballast circuit for lighting the plurality of dielectric barrier discharge lamps and configured to apply a high frequency voltage between the internal electrode and the external electrode of each dielectric barrier discharge lamp with a phase difference of 90 to 270 degrees between adjacent dielectric barrier discharge lamps.

2. The dielectric barrier discharge lamp lighting apparatus of claim 1, wherein the phase difference is set to 180 degrees.

3. The dielectric barrier discharge lamp lighting apparatus of claim 1, wherein the interval between adjacent dielectric barrier discharge lamps is 50 mm or less.

4. The dielectric barrier discharge lamp lighting apparatus of claim 2, wherein the interval between adjacent dielectric barrier discharge lamps is 50 mm or less.

5. The dielectric barrier discharge lamp lighting apparatus of claim 1, wherein the phase difference is set to 90 degrees.
